(19) United States
(12) Patent Application Publication
(10) Pub. No.: US 2005/0143263 A1
(43) Pub. Date: Jun. 30, 2005

(54) High temperature superconductor min-filters and coils and process for making them

(76) Inventor: Dean W. Face, Wilmington, DE (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 10/909,696

(22) Filed: Aug. 2, 2004

Related U.S. Application Data
(60) Provisional application No. 60/496,849, filed on Aug. 21, 2003.

(51) Int. Cl. H01P 1/203; H01B 12/02

(52) U.S. Cl. 505/210; 333/99 S; 333/204

(57) ABSTRACT

A process for producing high temperature superconductor (HTS) mini-filters or coils in which the high temperature superconductor films are deposited on a layer of CeO₂ on a substrate results in higher yields of mini-filters or coils.

This application claims the benefit of U.S. Provisional Application No. 60/496,849, filed Aug. 21, 2003, which is incorporated in its entirety as a part hereof for all purposes.

### FIELD OF THE INVENTION

This invention relates to high temperature superconductor (HTS) mini-filters comprised of self-resonant spiral resonators and HTS coils and the improvement in the process yield of such mini-filters and coils when they are produced using high temperature superconductor films deposited on a layer of CeO₂ on a substrate.

### BACKGROUND OF THE INVENTION

HTS filters have many applications in telecommunication, instrumentation and military equipment. The HTS filters have the advantages of extremely low in-band insertion loss, high off-band rejection and steep skirts due to the extremely low loss in the HTS materials. In one design, the HTS filters are comprised of spiral resonators that are large in size. In fact, at least one dimension of the resonator is equal to approximately a half wavelength. For low frequency HTS filters with many poles, the regular design requires a very large substrate area. The use of self-resonant spiral resonators to reduce the size of the HTS filters and solve cross-talk and connection problems reduces the size of the substrate area required. Nevertheless, the substrates of thin film HTS circuits are special single crystal dielectric materials that have a high cost. The HTS thin film coated substrates are even more costly. The mini-filter design must then be created on the HTS film typically using photoresist and ion etching techniques. The final cost is significant and it is commercially important to have a high yield of mini-filters that meet specifications.

HTS coils have applications as transmit, receive, and transmit and receive coils for electromagnetic signals. Producing these HTS coils requires the same steps that are used in producing the HTS filters. The related costs are also similar so that it is important to have a high yield of HTS coils that meet specifications.

U.S. Pat. No. 5,262,394 discloses a ceramic superconductor comprising a metal oxide substrate, a ceramic high temperature superconductive material, and an intermediate layer of a material having a cubic crystal structure. There nevertheless remains a need for a process for producing in high yield mini-filters and coils that meet required specifications, and the mini-filters and coils so produced.

An object of the present invention is to therefore provide a process for producing in high yield mini-filters and coils that meet required specifications.

### SUMMARY OF THE INVENTION

This invention provides a high temperature superconductor mini-filter comprised of at least two self-resonant spiral resonators, each of the spiral resonators independently comprising a high temperature superconductor line oriented in a spiral fashion, or a high temperature superconductor self-resonant planar coil comprised of a high temperature superconductor line oriented in a spiral fashion; and provides a process for the production of such HTS devices.

The process involves depositing an epitaxial layer of CeO₂ on a single crystal substrate, and forming an epitaxial high temperature superconducting film on the CeO₂ layer. The process also involves a step of forming from the HTS film one or more superconductor lines oriented in a spiral fashion. In one embodiment, the process involves:
(a) depositing an epitaxial layer of CeO₂ on a single crystal substrate;
(b) forming an epitaxial high temperature superconducting film on the CeO₂ layer;
(c) coating the high temperature superconducting film with a photoresist;
(d) exposing the photoresist to ultraviolet light through a photomask containing the mini-filter or coil design;
(e) developing the photoresist to produce the pattern of the mini-filter or coil in the photoresist;
(f) etching away the high temperature superconductor exposed when the photoresist was developed; and
(g) removing the remaining photoresist to expose the high temperature superconductor mini-filter or coil.

Preferably, the epitaxial layer of CeO₂ is deposited by sputter deposition while the substrate temperature is elevated. Preferably, the high temperature superconductor is etched away in step (f) using an argon beam and the remaining photoresist is removed in step (g) using oxygen plasma.

Preferably, an epitaxial layer of CeO₂ is deposited on both sides of the substrate and an epitaxial high temperature superconducting film is formed on the CeO₂ layer on both sides of the substrate. When producing a mini-filter, the high temperature superconducting film on the front side of the substrate is subsequently patterned as described above in steps (c)-(g) and the high temperature superconducting film on the back side of the substrate is used as a ground plane. The ground plane may be unpatterned or patterned. When there are superconducting layers on both sides of the substrate, both sides are coated with photoresist in step (c) above and in step (g) the remaining-photoresist on the front side and the photoresist on the back side are removed. The high temperature superconducting film on the back side is coated with a conductive film such as gold to provide good ground contact. When producing a coil, the high temperature superconducting film on the front side of the substrate and on the back side of the substrate is subsequently patterned as described above in steps (c)-(g). Both sides are coated with photoresist in step (c) and in step (g) the remaining photoresist is removed.

Preferably, the substrate is selected from the group consisting of LaAlO₃, MgO and Al₂O₃.

This invention also provides a high temperature superconductor mini-filter comprising at least two self-resonant spiral resonators, each of the spiral resonators independently comprising a high temperature superconductor line oriented in a spiral fashion such that adjacent lines of the spiral resonator are spaced from each other by a gap distance and so as to provide a central opening within the spiral resonator, wherein the at least two spiral resonators are in intimate contact with an epitaxial layer of CeO₂ that is on a single crystal substrate. In a further embodiment, the single crystal substrate may be selected from the group consisting of LaAlO₃, MgO and Al₂O₃.

In addition, this invention provides a high temperature superconductor self-resonant planar coil comprising a high temperature superconductor line oriented in a spiral fashion such that adjacent lines of the coil are spaced from each other by a gap distance and so as to provide a central opening within the coil, wherein the coil is in intimate contact with an epitaxial layer of CeO₂ that is on a single crystal substrate. In a further embodiment, the single crystal substrate may be selected from the group consisting of LaAlO₃, MgO and Al₂O₃.

This invention also provides a high temperature superconductor mini-filter comprising:
a) a single crystal substrate having a front side and a back side and preferably selected from the group consisting of LaAlO₃, MgO and Al₂O₃;
b) an epitaxial layer of CeO₂ on both sides of the substrate;
c) at least two self-resonant spiral resonators in intimate contact with the CeO₂ layer on the front side of the substrate, each of the spiral resonators independently comprising a high temperature superconductor line oriented in a spiral fashion such that adjacent lines of the spiral resonator are spaced from each other by a gap distance and so as to provide a central opening within the spiral resonator;
d) at least one inter-resonator coupling mechanism;
e) an input coupling circuit comprising a transmission line with a first end thereof connected to an input connector of the mini-filter and a second end thereof coupled to a first one of the spiral resonators;
f) an output coupling circuit comprising a transmission line with a first end thereof connected to an output connector of the mini-filter and a second end thereof coupled to a last one of the spiral resonators;
g) a high temperature superconductor film disposed on the CeO₂ layer on the back side of the substrate as a ground plane; and
h) a conductive film disposed on the high temperature superconductor film.

This invention also provides a high temperature superconductor mini-filter having a strip line form with all the features of the mini-filter described above and further comprising:
i) a superstrate having a front side and a back side, wherein the front side of the superstrate is positioned in intimate contact with the spiral resonators disposed on the front side of the substrate;
j) a high temperature superconductor film disposed on the back side of the superstrate as a ground plane; and
k) a conductive film disposed on the surface of the high temperature superconductor film disposed on the back side of the superstrate.

This invention also provides a high temperature superconductor self-resonant planar coil comprising:
a) a single crystal substrate having a front side and a back side and preferably selected from the group consisting of LaAlO₃, MgO and Al₂O₃;
b) an epitaxial layer of CeO₂ on the front side of the substrate; and
c) a high temperature superconductor line in intimate contact with the CeO₂ layer on the front side of the substrate, wherein the high temperature superconductor line is oriented in a spiral fashion such that adjacent lines of the spiral are spaced from each other by a gap distance and so as to provide a central opening within the spiral.

This invention also provides a high temperature superconductor self-resonant planar coil comprising:
a) a single crystal substrate having a front side and a back side and preferably selected from the group consisting of LaAlO₃, MgO and Al₂O₃;
b) an epitaxial layer of CeO₂ on both sides of the substrate; and
c) two high temperature superconductor lines, one in intimate contact with the CeO₂ layer on the front side of the substrate and one in intimate contact with the CeO₂ layer on the back side of the substrate, wherein each high temperature superconductor line is oriented in a spiral fashion such that adjacent lines of the spiral are spaced from each other by a gap distance and so as to provide a central opening within the spiral.

The high temperature superconductor used to form the high temperature superconductor line for all of the at least two improved self-resonant spiral resonators, for the high temperature superconductor films and for the high temperature superconductor coils is preferably selected from the group consisting of YBa₂Cu₃O₇, Tl₂Ba₂CaCu₂O₈, TlBa₂Ca₂Cu₃O₉, (TlPb)Sr₂CaCu₂O₇ and (TlPb)Sr₂Ca₂Cu₃O₉. Most preferably, the high temperature superconductor is Tl₂Ba₂CaCu₂O₈ or YBa₂Cu₃O₇.

The conductive films disposed on the surfaces of the high temperature superconductor ground plane films in the mini-filters described above can serve as contacts to the cases of the mini-filters. Preferably, these conductive films are gold films.

### BRIEF DESCRIPTION OF THE DRAWINGS

FIG. 1 shows the microstrip 8-pole filter configuration used in the example and the comparison experiment.

FIG. 2 shows the distribution of the reflection coefficient S₁₁ (in −dB) obtained for 8-pole mini-filters made using a Tl₂Ba₂CaCu₂O₈ film on LaAlO₃ with a CeO₂ layer.

FIG. 3 shows the distribution of the reflection coefficient S₁₁ (in −dB) obtained for 8-pole mini-filters made using a Tl₂Ba₂CaCu₂O₈ film on LaAlO₃ without a CeO₂ layer.

### DETAILED DESCRIPTION OF THE PREFERRED EMBODIMENTS

This invention provides a process for producing high temperature superconductor mini-filters or coils with high yield without concern for variations in substrates from batch to batch or from different suppliers. The deposition of an epitaxial buffer layer of CeO₂ on the substrate before the formation of the high temperature superconductor layer and the making of the mini-filter or coil will have different effects on the mini-filter or coil yield depending on the nature of the substrate. However, the routine use of the CeO₂ buffer layer reduces the uncertainty in the mini-filter or coil yield and provides consistently high mini-filter or coil yield. The use of a CeO₂ buffer layer will have similar beneficial advantages when producing other high temperature superconductor devices.

As used herein, “yield” means the percentage of the mini-filters or coils produced with acceptable performance characteristics.

The single crystal substrate is preferably selected from the group consisting of LaAlO₃, MgO and Al₂O₃ and LaAlO₃ is especially preferred. The surface of the substrate on which the epitaxial buffer layer of CeO₂ is to be deposited should be clean and polished. The epitaxial CeO₂ layer can be deposited by various known methods but off-axis sputter deposition is preferred and the substrate temperature should be elevated, i.e., about 600-900° C., preferably about 700-800° C., during the deposition.

The high temperature superconductor used to form the HTS lines for all of the self-resonant spiral resonators is preferably selected from the group consisting of YBa₂Cu₃O₇, Tl₂Ba₂CaCu₂O₈, TlBa₂Ca₂Cu₃O₉, (TlPb)Sr₂CaCu₂O₇ and (TlPb)Sr₂Ca₂Cu₃O₉. Most preferably, the high temperature superconductor is Tl₂Ba₂CaCu₂O₈ or YBa₂Cu₃O₇. Various methods are known for depositing each of these high temperature superconductors and any of these methods that result in an epitaxial layer of the HTS on the CeO₂ layer can be used.

The use of photoresists to produce patterned elements is well known in the electronics industry and these standard methods can be used to make the patterned mini-filter or coil configuration from the unpatterned HTS layer. Preferably, the HTS to be removed is etched away using an argon beam and the photoresist covering the HTS filter or coil is removed using oxygen plasma.

The high temperature superconductor mini-filter made by this process is comprised of at least two self-resonant spiral resonators, each of the spiral resonators independently comprising a high temperature superconductor line oriented in a spiral fashion such that adjacent lines of the spiral resonator are spaced from each other by a gap distance and so as to provide a central opening within the spiral resonator. Preferably, the gap distance is less than the width of the high temperature superconductor line and the dimensions of the central opening are approximately equal to the gap distance. A conductive tuning pad may be placed in the central opening to fine tune the frequency of the spiral resonator. This tuning pad can be a high temperature superconductor.

Preferably, all the self-resonant spiral resonators in a mini-filter have an identical shape, i.e., rectangular, rectangular with rounded corners, polygonal with more than four sides or circular.

The input and output coupling circuits of the mini-filter have two basic configurations:
1. Parallel lines configuration which comprises a transmission line with a first end thereof connected to an input connector of the filter via a gold pad on top of the line, and a second end thereof is extended to be close by and in parallel with the spiral line of the first spiral resonator (for the input circuit) or the last spiral resonator (for the output circuit) to provide the input or output couplings for the filter;
2. Inserted line configuration which comprises a transmission line with a first end thereof connected to an input connector of the filter via a gold pad on top of the line, and a second end thereof is extended to be inserted into the split spiral line of the first spiral resonator (for the input circuit) or the last spiral resonator (for the output circuit) to provide the input or output couplings for the filter.

The inter-resonator couplings between adjacent spiral resonators in the mini-filter are provided by the overlapping of the electromagnetic fields at the edges of the adjacent spiral resonators. In addition, HTS lines can be provided between the spiral resonators to increase coupling and adjust the frequency of the mini-filter.

The mini-filters of this invention can be in the microstrip line form with one substrate and one ground plane; they also can be in the strip line form with a substrate, a superstrate and two ground planes.

As the number of self-resonant spiral resonators in the mini-filter increases, the difficulty of obtaining high yields of mini-filters also increases and the advantage of using the process of this invention to produce the mini-filters increases.

The use of a CeO₂ buffer layer will have similar beneficial advantages when producing high temperature superconductor self-resonant planar coils. The planar coil, i.e., surface coil, can have a HTS coil configuration on just one side of the substrate or essentially identical HTS coil configurations on both sides of the substrate. The coil configuration is comprised of a high temperature superconductor line oriented in a spiral fashion. Adjacent lines of the spiral are spaced from each other by a gap distance and provide a central opening within the spiral. The width of the HTS line can be uniform or can vary along the length of the spiral. Similarly, the gap distance can be uniform or can vary along the length of the spiral.

An HTS mini-filter according to this invention may be used in a variety of electronic devices such as a cryogenic receiver front end. An HTS coil according to this invention may also be used in a variety of electronic devices such as a nuclear quadrupole resonance (“NQR”) detection system. An NQR detection system can be used to detect the presence of chemical compounds for any purpose, but is particularly useful for detecting the presence of controlled substances such as explosives, drugs or contraband of any kind. Such an NQR detection system could be usefully incorporated into a safety system, a security system, or a law enforcement screening system. For example, these systems can be used to scan persons and their clothing, carry-on articles, luggage, cargo, mail and/or vehicles. They can also be used to monitor quality control, to monitor air or water quality, and to detect biological materials.

### EXAMPLE OF THE INVENTION AND Comparative Experiment

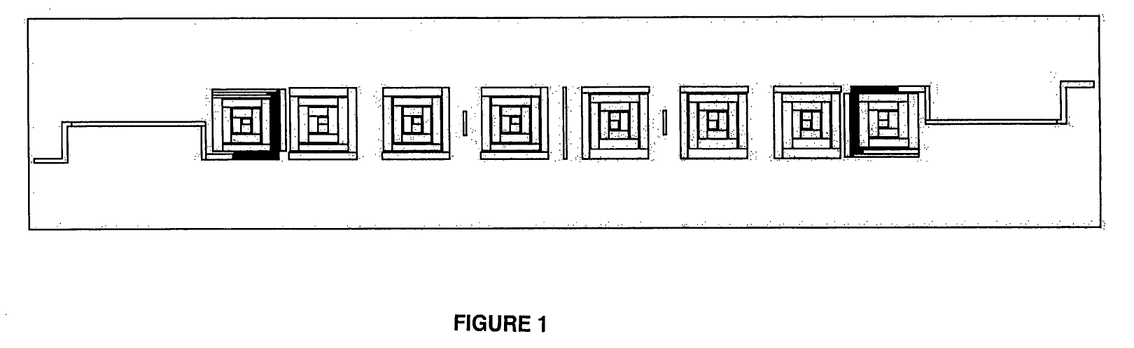

This example in which seventeen 8-pole mini-filters, each with the design shown in FIG. 1, were produced using double-sided Tl₂Ba₂CaCu₂O₈ on a CeO₂ buffered LaAlO₃ substrate illustrates the high yield obtainable using the process of this invention.

A clean, polished single crystal LaAlO₃ substrate was obtained from MTI Corporation, Richmond, Calif. An epitaxial CeO₂ buffer layer was grown on both sides of the substrate by off-axis sputter deposition with the substrate temperature held in the range of about 700-800° C.

Off-axis magnetron sputtering of a Ba:Ca:Cu oxide target was used to deposit, at room temperature (about 20° C.), an amorphous precursor Ba:Ca:Cu oxide film onto the CeO₂ layer on both sides of the substrate. This amorphous precursor Ba:Ca:Cu oxide film was about 550 nm thick and had a stoichiometry of about 2:1:2. The precursor film was then thallinated by annealing it in air for about 45 minutes at about 850° C. in the presence of a powder mixture of Tl₂Ba₂Ca₂Cu₃O₁₀ and Tl₂O₃. When this powder mixture is heated, Tl₂O evolves from the powder mixture, diffuses to the precursor film and reacts with it to form the desired Tl₂Ba₂CaCu₂O₈ phase. Standard X-ray diffraction measurements show that the Tl₂Ba₂CaCu₂O₈ film has an in-plane alignment which is determined by the underlying CeO₂ buffer layer with the [100] crystal axis of the Tl₂Ba₂CaCu₂O₈ film rotated by 45° with respect to the [100] crystal axis of the CeO₂ buffer layer.

The Tl₂Ba₂CaCu₂O₈ film surface was then cleaned using an argon ion beam. A gold film was evaporated onto and completely covered the unpatterned Tl₂Ba₂CaCu₂O₈ film on the back side of the substrate. Gold contact pads were evaporated through a shadow mask onto the front side Tl₂Ba₂CaCu₂O₈ film surface. The sample was then coated with photoresist on both sides and baked. A filter design photomask containing the design for three mini-filters, each with the design shown in FIG. 1, was prepared. The input and output coupling circuits have the inserted line configuraton. The gap between the HTS lines of the resonators was 44 μm. The width of the HTS lines of the resonators varied from 220 μm to 308 μm. The design of the resonators and inter-resonator couplings was optimized using Sonnet EM software, obtained from Sonnet Software, Inc, Liverpool, N.Y. 13088. The filter design photomask was then placed on the photoresist covering the Tl₂Ba₂CaCu₂O₈ film on the front side of the substrate and exposed to ultraviolet light. The resist was then developed and the portion of the Tl₂Ba₂CaCu₂O₈ film exposed when the resist was developed was etched away by argon beam etching. The remaining photoresist layer on the front and back sides of the substrate was then removed by an oxygen plasma. A dicing saw was then used to section the three individual mini-filters.

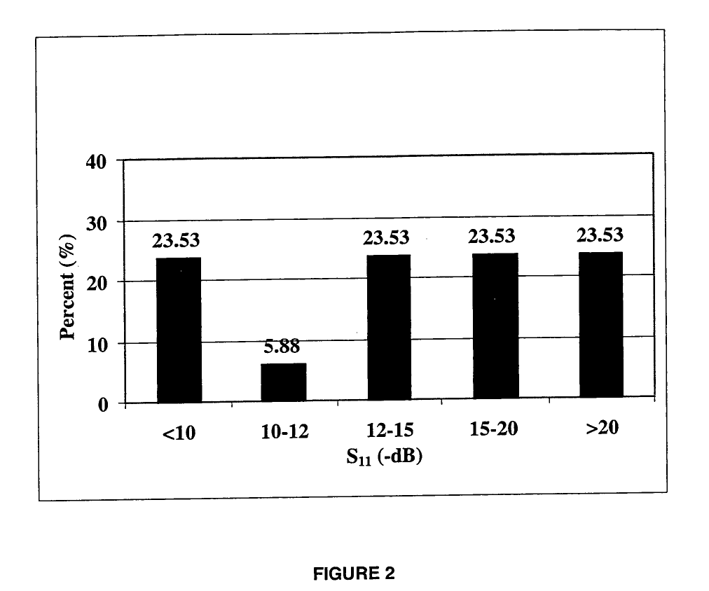

17 mini-filters prepared as described above were obtained for analysis. S₁₁ is the magnitude of the reflection coefficient from the input port. S₁₁ is an important parameter for practical applications of these mini-filters and is used here to characterize the mini-filters produced. S₁₁ outside the band-pass region is nearly 1, i.e., about 0 dB. S₁₁ in the band-pass region should be as small as possible. S₁₁ was measured for each of the 17 mini-filters. The percentage of mini-filters with an S₁₁ in the band-pass region between 0 and −10 dB, between −10 db and −12 dB, between −12 db and −15 dB, between −15 dB and −20 dB and smaller than −20 dB are shown in FIG. 2. Over 70% of the mini-filters have an S₁₁ in the band-pass region smaller than −12 dB.

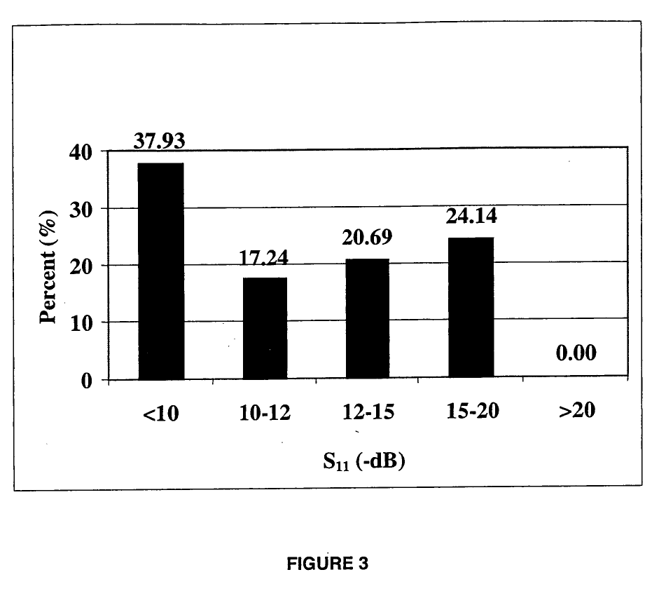

A comparative experiment was carried out preparing the mini-filters essentially as described above except for the omission of the deposition of the CeO₂ layer. 29 mini-filters were obtained for analysis. The percentage of mini-filters with an S₁₁ in the band-pass region between 0 and −10 dB, between −10 db and −12 dB, between −12 db and −15 dB, between −15 dB and −20 dB and smaller than −20 dB are shown in FIG. 3. Less than 45% of the mini-filters have an S₁₁ in the band-pass region smaller than −12 dB. This compares with the over 70% in that range for the mini-filters of the invention. The CeO₂ buffer layer isolates and protects the filter from the influence of and interaction with the LaAlO₃ substrate. The CeO₂ buffer layer results in the high yield necessary for a practical process.

Where an apparatus or method of this invention is stated or described as comprising, including, containing, having, being composed of or being constituted by certain components or steps, it is to be understood, unless the statement or description explicitly provides to the contrary, that one or more components or steps other than those explicitly stated or described may be present in the apparatus or method. In an alternative embodiment, however, the apparatus or method of this invention may be stated or described as consisting essentially of certain components or steps, in which embodiment components or steps that would materially alter the principle of operation or the distinguishing characteristics of the apparatus or method would not be present therein. In a further alternative embodiment, the apparatus or method of this invention may be stated or described as consisting of certain components or steps, in which embodiment components or steps other than those as stated would not be present therein.

Where the indefinite article “a” or “an” is used with respect to a statement or description of the presence of a component in an apparatus, or a step in a method, of this invention, it is to be understood, unless the statement or description explicitly provides to the contrary, that the use of such indefinite article does not limit the presence of the component in the apparatus, or of the step in the method, to one in number.

1. A process for producing (i) a high temperature superconductor mini-filters comprised of at least two self-resonant spiral resonators, each of the spiral resonators independently comprising a high temperature superconductor line oriented in a spiral fashion, or (ii) a high temperature superconductor self-resonant planar coil comprised of a high temperature superconductor line oriented in a spiral fashion; the process comprising:
(a) depositing an epitaxial layer of CeO₂ on a single crystal substrate; and
(b) forming an epitaxial high temperature superconducting film on the layer of CeO₂.

2. The process of claim 1 wherein the substrate is selected from the group consisting of LaAlO₃, MgO and Al₂O₃.

3. The process of claim 2 wherein the substrate is LaAlO₃.

4. The process of claim 1 further comprising:
(c) coating the high temperature superconducting film with a photoresist;
(d) exposing the photoresist to ultraviolet light through a photomask containing the mini-filter or coil design;
(e) developing the photoresist to produce the pattern of the mini-filter or coil in the photoresist;
(f) etching away the high temperature superconductor exposed when the photoresist was developed; and
(g) removing the remaining photoresist to expose the high temperature superconductor mini-filter or coil.

5. The process of claim 4 wherein the layer of CeO₂ is formed by off-axis sputter deposition with the substrate temperature maintained in the range of about 600-900° C. during the deposition.

6. The process of claim 5 wherein the substrate temperature is maintained in the range of about 700-800° C.

7. The process of claim 1 wherein the single crystal substrate has a front side and a back side, the epitaxial layer of CeO₂ is deposited on both sides of the substrate, and the epitaxial high temperature superconducting film is formed on the layer of CeO₂ on both the sides of the substrate.

8. The process of claim 7 wherein the substrate is selected from the group consisting of LaAlO₃, MgO and Al₂O₃.

9. The process of claim 8 wherein the substrate is LaAlO₃.

10. The process of claim 7 wherein each layer of CeO₂ is formed by off-axis sputter deposition with the substrate temperature maintained in the range of about 600-900° C. during the deposition.

11. The process of claim 10 wherein the substrate temperature is maintained in the range of about 700-800° C.

12. The process of claim 7 wherein a high temperature superconductor mini-filter is produced, further comprising:
(c) coating the high temperature superconducting film on both the sides of the substrate with a photoresist;
(d) exposing the photoresist on the front side of the substrate to ultraviolet light through a photomask containing the mini-filter design;
(e) developing the photoresist to produce the pattern of the mini-filter in the photoresist on the front side of the substrate;
(f) etching away the high temperature superconductor exposed on the front side of the substrate when the photoresist was developed; and
(g) removing the remaining photoresist to expose the high temperature superconductor mini-filter on the front side of the substrate and the high temperature superconducting film on the back side of the substrate.

13. The process of claim 7 wherein a high temperature superconductor coil is produced, further comprising:
(c) coating the high temperature superconducting film on both the sides of the substrate with a photoresist;
(d) exposing the photoresist on both the sides of the substrate to ultraviolet light through a photomask containing the coil design;
(e) developing the photoresist to produce the pattern of the coil design in the photoresist on both the sides of the substrate;
(f) etching away the high temperature superconductor exposed on both the sides of the substrate when the photoresist was developed; and
(g) removing the remaining photoresist to expose the high temperature superconductor coil design on both the sides of the substrate.

14. A high temperature superconductor mini-filter comprising at least two self-resonant spiral resonators, each spiral resonator independently comprising a high temperature superconductor line oriented in a spiral fashion such that adjacent lines of the spiral resonator are spaced from each other by a gap distance and so as to provide a central opening within the spiral resonator, wherein each spiral resonator is in intimate contact with an epitaxial layer of CeO₂ that is on a single crystal substrate.

15. The high temperature superconductor mini-filter of claim 14 wherein the single crystal substrate is selected from the group consisting of LaAlO₃, MgO and Al₂O₃.

16. The high temperature superconductor mini-filter of claim 15 wherein the substrate is LaAlO₃.

17. A high temperature superconductor mini-filter comprising:
(a) a single crystal substrate having a front side and a back side;
(b) an epitaxial layer of CeO₂ on both sides of the substrate;
(c) at least two self-resonant spiral resonators in intimate contact with the layer of CeO₂ on the front side of the substrate, each spiral resonator independently comprising a high temperature superconductor line oriented in a spiral fashion such that adjacent lines of the spiral resonator are spaced from each other by a gap distance and so as to provide a central opening within the spiral resonator;
(d) at least one inter-resonator coupling mechanism;
(e) an input coupling circuit comprising a transmission line with a first end thereof connected to an input connector of the mini-filter and a second end thereof coupled to a first one of the spiral resonators;
(f) an output coupling circuit comprising a transmission line with a first end thereof connected to an output connector of the mini-filter and a second end thereof coupled to a last one of the spiral resonators;
(g) a high temperature superconductor film disposed on the layer of CeO₂ on the back side of the substrate as a ground plane; and
(h) a conductive film disposed on the high temperature superconductor film.

18. The high temperature superconductor mini-filter of claim 17 wherein the high temperature superconducting layer on the back side of the substrate is maintained unpatterned.

19. The high temperature superconductor mini-filter of claim 17 wherein the substrate is selected from the group consisting of LaAlO₃, MgO and Al₂O₃.

20. The high temperature superconductor mini-filter of claim 19 wherein the substrate is LaAlO₃.

21. The high temperature superconductor mini-filter of claim 17 further comprising:
(i) a superstrate having a front side and a back side, wherein the front side of the superstrate is positioned in intimate contact with the resonators disposed on the front side of the substrate;
(j) a high temperature superconductor film disposed on the back side of the superstrate as a ground plane; and
(k) a conductive film disposed on the high temperature superconductor film.

22. The high temperature superconductor mini-filter of claim 21 wherein the high temperature superconductor film disposed on the back side of the superstrate is maintained unpatterned.

23. The high temperature superconductor mini-filter of claim 21 wherein the substrate is selected from the group consisting of LaAlO₃, MgO and Al₂O₃.

24. The high temperature superconductor mini-filter of claim 23 wherein the substrate is LaAlO₃.

25. A high temperature superconductor self-resonant planar coil comprising:
(a) a single crystal substrate having a front side and a back side;
(b) an epitaxial layer of CeO₂ on the front side of the substrate; and
(c) a high temperature superconductor line in intimate contact with the CeO₂ layer on the front side of the substrate, wherein the high temperature superconductor line is oriented in a spiral fashion such that adjacent lines of the spiral are spaced from each other by a gap distance and so as to provide a central opening within the spiral.

26. The high temperature superconductor coil of claim 25 wherein the substrate is selected from the group consisting of LaAlO₃, MgO and Al₂O₃.

27. The high temperature superconductor coil of claim 26 wherein the substrate is LaAlO₃.

28. A high temperature superconductor self-resonant planar coil comprising:
(a) a single crystal substrate having a front side and a back;
(b) an epitaxial layer of CeO₂ on both the sides of the substrate; and
(c) two high temperature superconductor lines, one in intimate contact with the CeO₂ layer on the front side of the substrate and one in intimate contact with the CeO₂ layer on the back side of the substrate, wherein each high temperature superconductor line is oriented in a spiral fashion such that adjacent lines of the spiral are spaced from each other by a gap distance and so as to provide a central opening within the spiral.

29. The high temperature superconductor coil of claim 28 wherein the substrate is selected from the group consisting of LaAlO₃, MgO and Al₂O₃.

30. The high temperature superconductor coil of claim 29 wherein the substrate is LaAlO₃.

31. A cryogenic receiver front end comprising an HTS mini-filter according to claim 14.

32. A nuclear quadrupole resonance detection system comprising an HTS self-resonant planar coil according to claim 25.
